(19) United States
(12) Patent Application Publication
(10) Pub. No.: US 2015/0358260 A1
(43) Pub. Date: Dec. 10, 2015

(54) DYNAMIC BUDDY LIST MANAGEMENT BASED ON MESSAGE CONTENT

(71) Applicant: CA, Inc., Islandia, NY (US)

(72) Inventors: Norman Jordan, Vancouver (CA); Chris Irving, Vancouver (CA)

(21) Appl. No.: 14/299,219

(22) Filed: Jun. 9, 2014

(51) Int. Cl. H04L 12/58

(52) U.S. Cl. CPC H04L 51/046; H04L 51/16; H04L 51/12

(57) ABSTRACT

A gateway includes a proxy that selectively forwards messages to a messaging server based on the sender's authorization status. If the sender is authorized to send messages, the proxy applies a set of predetermined rules to dynamically control user identification information included in the buddy lists on the messaging clients based on the content of messages exchanged between messaging client users.

### BACKGROUND

The present disclosure relates to buddy list management, and in particular, dynamically managing buddy lists based on content of messages.

Chat and instant messaging applications typically allow a user to create a buddy list, which displays the presence status (e.g., online, offline, busy, etc.) of other users included on the buddy list. To add someone to a buddy list, the user typically must send a request to the desired user for inclusion on the buddy list, and the intended user must respond with approval to be included on the buddy list. This process can be cumbersome for users who must send or respond to many such requests.

In addition, for chat and instant messaging application used in an organization, inclusion on a buddy list may or may not be desirable based on a user's role in the organization. For example, it may be desirable for all engineers in an organization to be included on a buddy list for messages pertaining to engineering issues. Conversely, it may be undesirable for certain employees to be included in a buddy list for messages pertaining to management and executive-level issues.

### BRIEF SUMMARY

According to one aspect of the present disclosure, a system is provided for use with a plurality of messaging clients, each messaging client running on a corresponding computing device and including a corresponding buddy list. The system includes a server and a computer-readable medium in communication with the server, the computer-readable medium having a plurality of instructions stored thereon which, when executed by the server, cause the server to receive messages from the messaging clients, and dynamically control user identification information included in the buddy lists based on content of messages received from the messaging clients.

According to another aspect of the disclosure, a computer program product is provided that includes a computer readable storage medium having computer readable program code embodied therewith, the computer readable program code including computer readable program code configured to cause a server to receive messages from a plurality of messaging clients, each messaging client comprising a corresponding buddy list, and computer readable program code configured to cause the server to dynamically control user identification information included in the buddy lists based on content of messages received from the messaging clients.

According to another aspect of the disclosure, a method is provided for dynamically controlling buddy lists of messaging clients, each messaging client running on a corresponding computing device. The method includes receiving messages from the messaging clients at a server, determining content of the received messages at the server, and dynamically controlling user identification information included in the buddy lists based on the determined content of the received messages at the server.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 illustrates a high-level block diagram of an apparatus or system comprising networked computing devices for dynamically managing buddy lists on a gateway according to an embodiment.

FIG. 2 illustrates a messaging client user interface according to an embodiment.

FIG. 3 illustrates a content-based message authorization proxy according to an embodiment.

FIG. 4 is a flowchart illustrating a protocol for selectively forwarding messages to a messaging server based on the sender's authorization status, and dynamically managing buddy lists on a gateway according to an embodiment.

FIGS. 5A-5G illustrate an access control list according to an embodiment.

FIG. 6 illustrates a criteria and rules database according to an embodiment.

FIGS. 7A-7C illustrate example messages exchanged in apparatus or systems according to an embodiment.

FIGS. 8A-8C illustrate example messages exchanged in apparatus or systems according to an embodiment.

FIG. 9 is a block diagram of a computing device environment according to an embodiment.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer (or computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (or computing device), special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

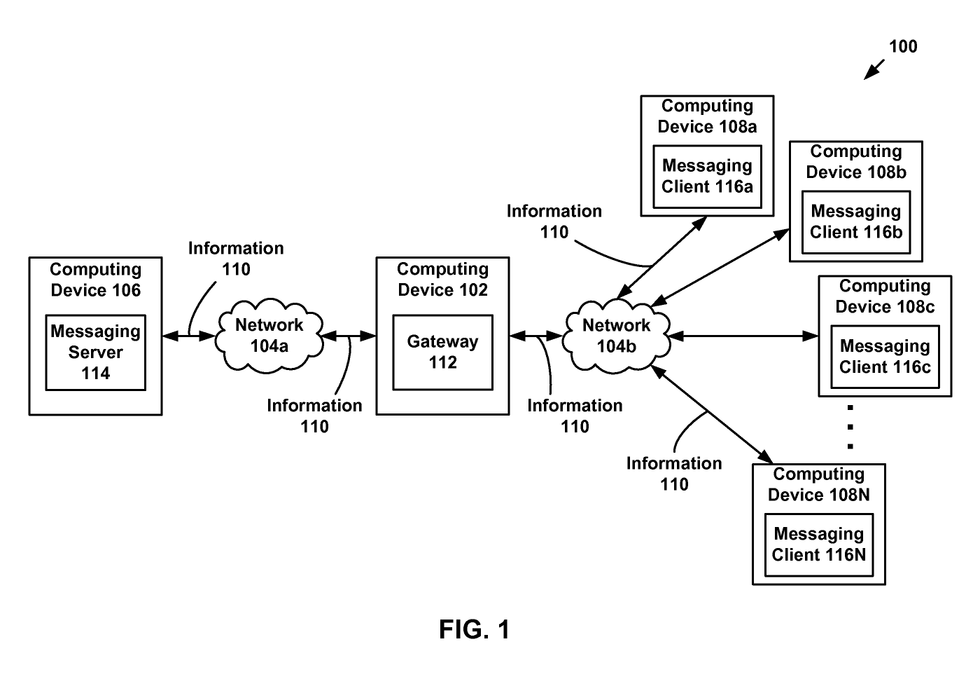

FIG. 1 is a high-level block diagram of a system 100 including networked computing devices that include a gateway, a messaging server, such as an XMPP server, and messaging clients, such as XMPP messaging clients. Each of the messaging clients may be used by messaging client users (not shown) to compose, display and send messages, such as chat messages, instant messages, SMS messages, MMS messages, and other similar messages (collectively, “Messages”) to other messaging clients. Each messaging client user has associated user identification information, such as a username (e.g., “John,” “Sally,” etc.), email address, phone number, or other similar identification information of the user using the messaging client. For simplicity, user identification information will be referred to in the remaining discussion as “username.” Each of the messaging clients may include a buddy list that may be used to include the usernames of other messaging client users, and display presence status (e.g., online, offline, busy) associated with each username. As used herein, a user sending a Message is referred to as a “Sender,” and a designated recipient of a Message is a “Recipient.”

Messages sent by the messaging clients are processed by the gateway, which includes a proxy that selectively forwards the Messages to the messaging server based on the Sender's authorization status (e.g., “AUTHORIZED” or “BLOCKED”). If the Sender is AUTHORIZED, the proxy applies a set of predetermined rules to dynamically control the usernames included in the buddy lists on the messaging clients based on the content of Messages exchanged between messaging client users. The predetermined rules may specify that the Sender's authorization status should be changed to “BLOCKED.” After implementing the predetermined rules, the proxy selectively forwards the Messages to the messaging server based on the Sender's authorization status. If the Sender is AUTHORIZED, the proxy forwards the Messages to the messaging server. If the Sender is BLOCKED, the proxy may discard the Message or may reply to the Sender indicating that the Message has been blocked.

In an embodiment, system 100 includes a first computing device 102 that communicates via a first network 104a with a second computing device 106, and communicates via a second network 104b with third computing devices 108a, 108b, 108c, . . . , 108N. First computing device 102 may be remotely located from second computing device 106 and third computing devices 108a, 108b, 108c, . . . , 108N. First computing device 102 may be external to second computing device 106 and/or third computing devices 108a, 108b, 108c, . . . , 108N, or alternatively one or more of first computing device 102, second computing device 106 and third computing devices 108a, 108b, 108c, . . . , 108N may be the same computing device. Persons of ordinary skill in the art will understand that system 100 alternatively may include additional computing devices that communicate with one another via first network 104a and/or second network 104b.

In an embodiment, first computing device 102 may be a server and second computing device 106 and third computing devices 108a, 108b, 108c, . . . , 108N each may be a client of first computing device 102. For example, first computing device 102 may be a server providing information, such as information 110, to second computing device 106 and third computing devices 108a, 108b, 108c, . . . , 108N that each act as a client. First computing device 102 may be a computer server, a desktop computer, a laptop computer, a data center, or other similar computing device. Second computing device 106 and third computing devices 108a, 108b, 108c, . . . , 108N each may be a desktop computer, a laptop computer, a mobile computing device such as a cell phone, laptop computer, notebook or tablet, or other similar computing device. In another embodiment, first computing device 102, second computing device 106 and third computing devices 108a, 108b, 108c, . . . , 108N may be peers. In a peer-to-peer (P2P) embodiment, first computing device 102, second computing device 106 and third computing devices 108a, 108b, 108c, . . . , 108N each may act as a client or a server of the other.

In an embodiment, each of first network 104a and second network 104b may be the Internet, a Wide Area Network (WAN) or a Local Area Network (LAN), singly or in combination. First network 104a and second network 104b may be separate networks or may be the same network. In embodiments, first computing device 102, second computing device 106 and third computing devices 108a, 108b, 108c, . . . , 108N may use one or more protocols, such as Transmission Control Protocol/Internet Protocol (TCP/IP), to transfer Information 110. In embodiments, first computing device 102, second computing device 106 and third computing devices 108a, 108b, 108c, . . . , 108N may be included in the same network or may be in separate networks. Information 110 may be transferred between first computing device 102, second computing device 106 and third computing devices 108a, 108b, 108c, . . . , 108N by wire and/or wirelessly in first network 104 and second network 104b.

In an embodiment, first computing device 102 includes a Gateway 112, second computing device 106 includes a Messaging Server 114, and third computing devices 108a, 108b, 108c, . . . , 108N include Messaging Clients 116a, 116b, 116c, . . . , 116N, respectively, that may be used to compose, display and send Messages to other Messaging Clients 116a, 116b, 116c, . . . , 116N via Gateway 112 and Messaging Server 114. As described in more detail below, Gateway 112 includes a proxy that selectively forwards the Messages to Messaging Server 114 based on the Sender's authorization status, and applies a set of predetermined rules to dynamically control the usernames included in the buddy lists on Messaging Clients 116a, 116b, 116c, . . . , 116N based on the content of Messages exchanged between Messaging Client users.

Gateway 112 may be a hardware and/or software gateway, such as a Layer 7 SecureSpan XML Networking Gateway, by Layer? Technologies, Vancouver, BC. Messaging Server 114 may be a hardware and/or software messaging server, such as an XMPP server that provides messaging, presence, and XML routing features. For example, Messaging Server 114 may be a software XMPP messaging server, such as a CommuniGate Pro server by CommuniGate Systems, Larkspur, Calif. Persons of ordinary skill in the art will understand that Messaging Server 114 may be implemented on second computing device 106, or alternatively may be implemented as a messaging server (e.g., an XMPP messaging server) on Gateway 112. Messaging Clients 116a, 116b, 116c, . . . , 116N may be messaging client software compatible with Messaging Server 114. For example, Messaging Clients 116a, 116b, 116c, . . . , 116N may be XMPP messaging clients, such as Windows Live Messenger by Microsoft Corporation, Redmond, Wash. Persons of ordinary skill in the art will understand that other gateways, messaging servers and messaging clients may be used. Persons of ordinary skill in the art also will understand that Messaging Clients 116a, 116b, 116c, . . . , 116N need not be the same messaging client software.

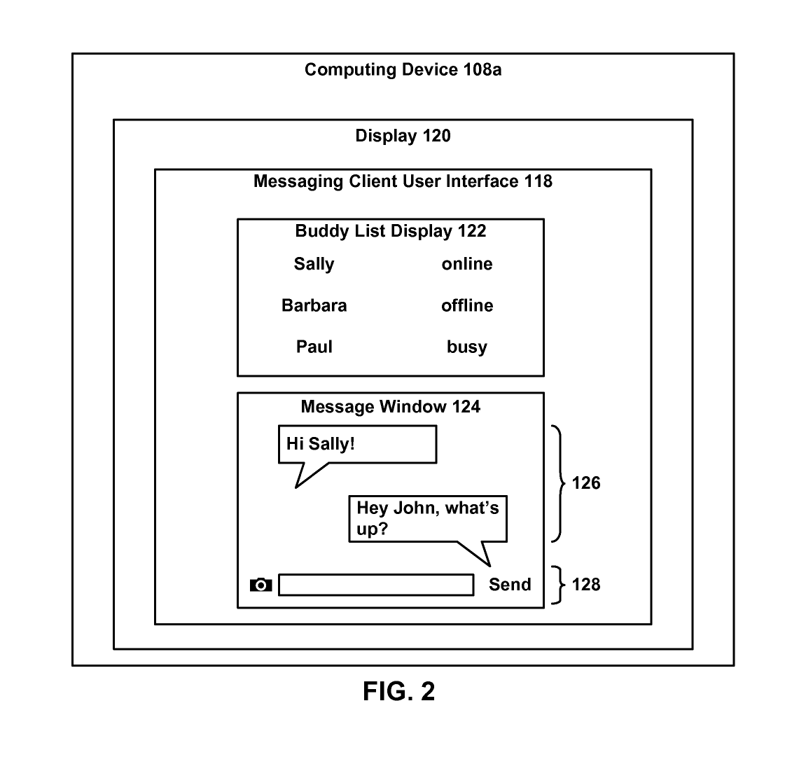

As described above, Messaging Clients 116a, 116b, 116c, . . . , 116N may be used to compose, display and send Messages to other Messaging Clients 116a, 116b, 116c, . . . , 116N via Gateway 112 and Messaging Server 114. Referring now to FIG. 2, an example user interface 118 of a Messaging Client (e.g., Messaging Client 116a) is described. In an embodiment, Messaging Client User Interface 118 may be displayed on a display 120 (e.g., a computer display, touch screen, or other similar display) of third computing device 108a. Messaging Client User Interface 118 includes a Buddy List Display 122 and a Message Window 124. Buddy List Display 122 displays the usernames of users that are included in the buddy list of Messaging Client 116a, and the current online status (e.g., online, offline, busy) associated with each username. Message Window 124 includes a chat display area 126 and a Message composition area 128, and in the illustrated example, shows a chat session between a first user (e.g., John) of Messaging Client 116a, and a second user (e.g., Sally) of another messaging client (e.g., Messaging Client 116b) operating on another third computing device (e.g., third computing device 108b).

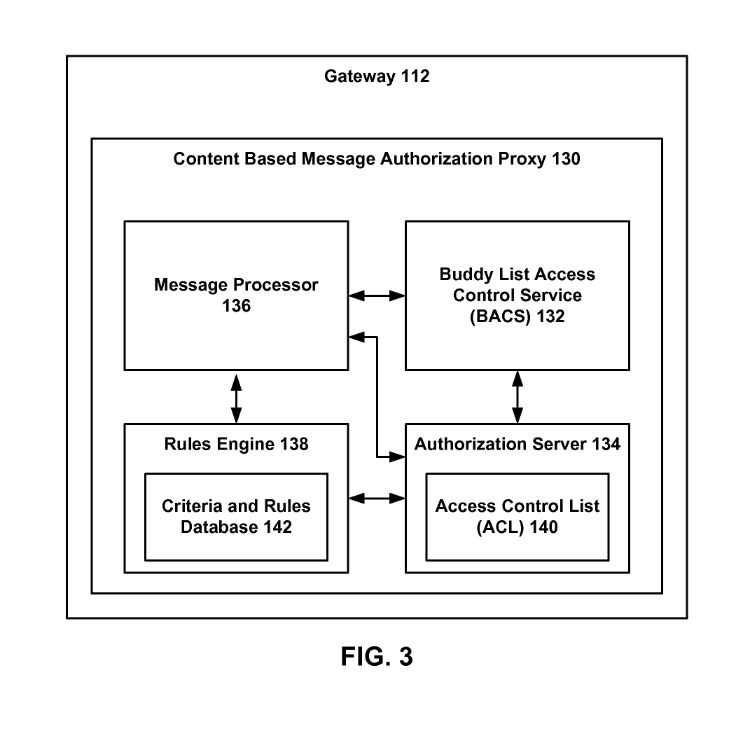

Referring now to FIG. 3, an example Gateway 112 is described. Gateway 112 includes a Content-Based Message Authorization Proxy 130 that selectively forwards Messages received from Messaging Clients 116a, 116b, 116c, . . . , 116N to Messaging Server 114 based on the Sender's authorization status, and applies a set of predetermined rules to dynamically control the usernames included in the buddy lists on Messaging Clients 116a, 116b, 116c, . . . , 116N based on the content of Messages exchanged between Messaging Client users. In an embodiment, Content-Based Message Authorization Proxy 130 includes Buddy List Access Control Service (BACS) 132, Authorization Server 134, Message Processor 136 and Rules Engine 138. Authorization Server 134 includes an Access Control List (“ACL”) 140, and Rules Engine 138 includes a Criteria and Rules Database 142. Persons of ordinary skill in the art will understand that Content-Based Message Authorization Proxy 130 alternatively may include more, fewer or different components than the ones illustrated in FIG. 3, and that some of the components may be combined.

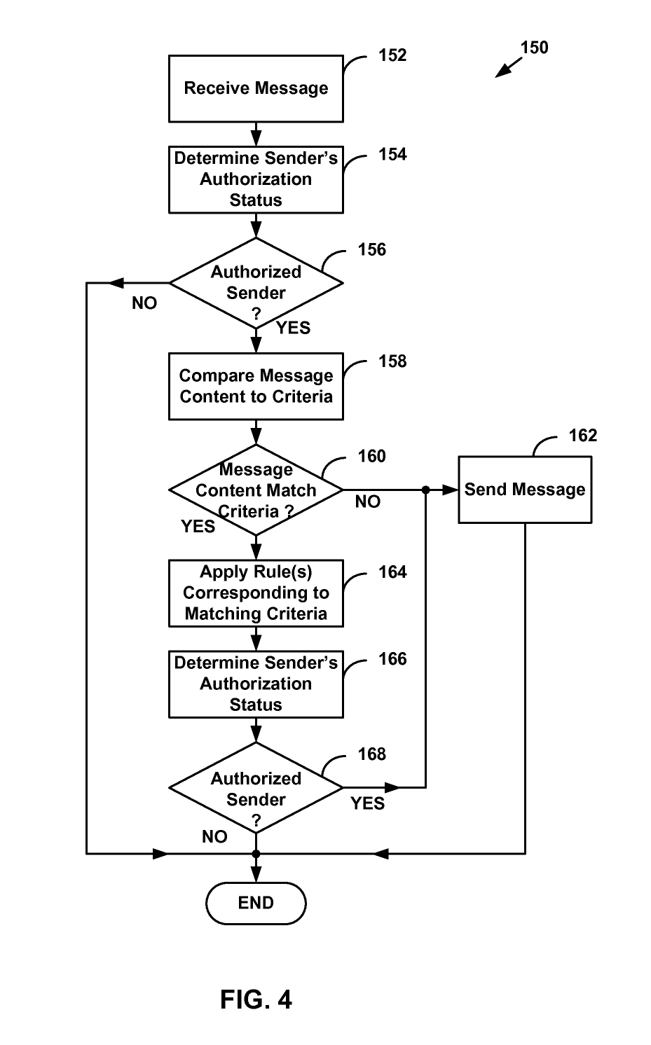

Referring to FIGS. 3 and 4, an example process 150 performed by Content-Based Message Authorization Proxy 130 is described. At step 152, BACS 132 receives a Message from one of Messaging Clients 116a, 116b, . . . , 116N, and determines the username associated with the received Message. At step 154, BACS 132 determines the authorization status associated with the Sender. In particular, BACS 132 forwards the Sender's username to Authorization Server 134, which uses ACL 140 to determine the authorization status associated with the received username, and then provides the associated authorization status to BACS 132.

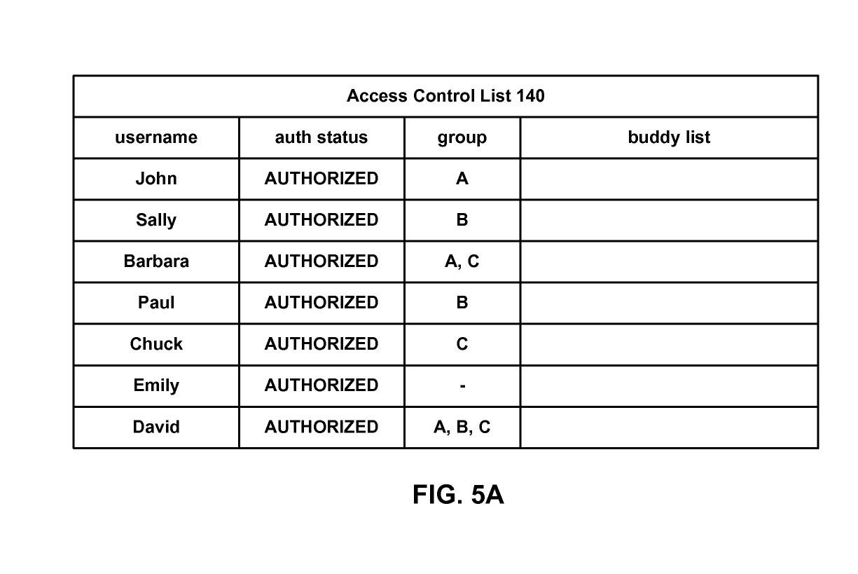

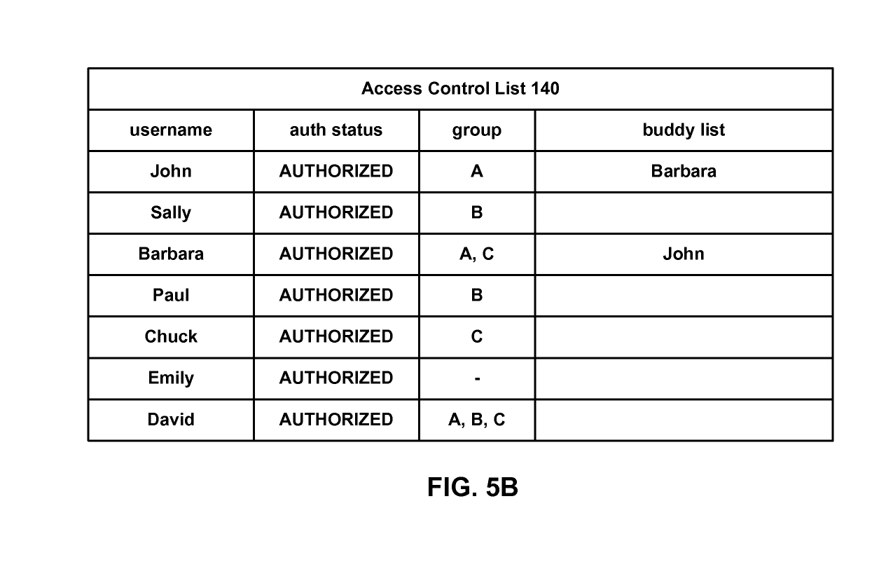

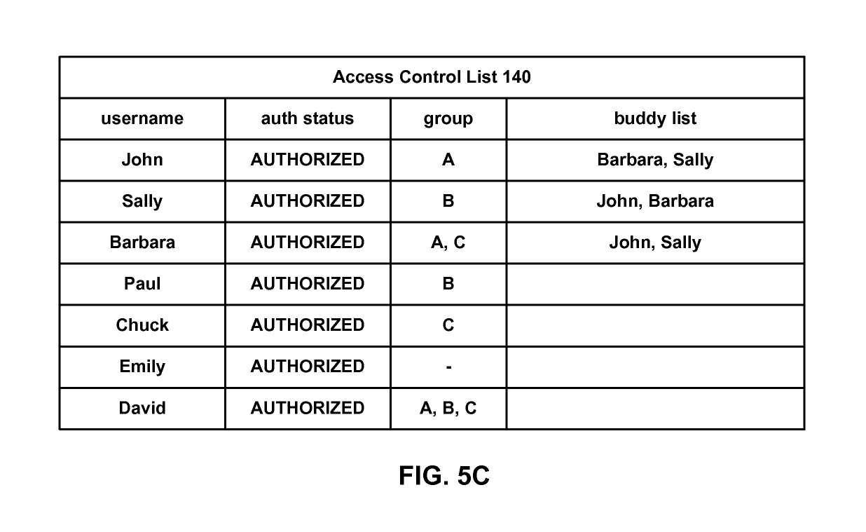

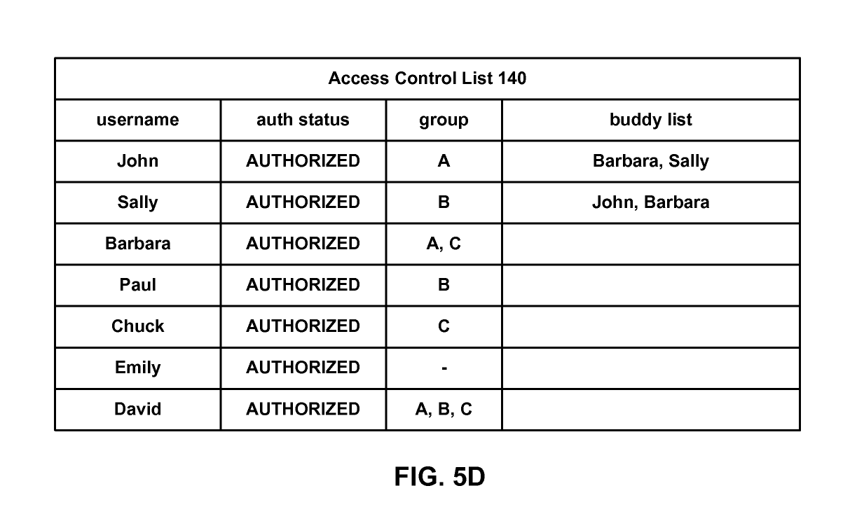

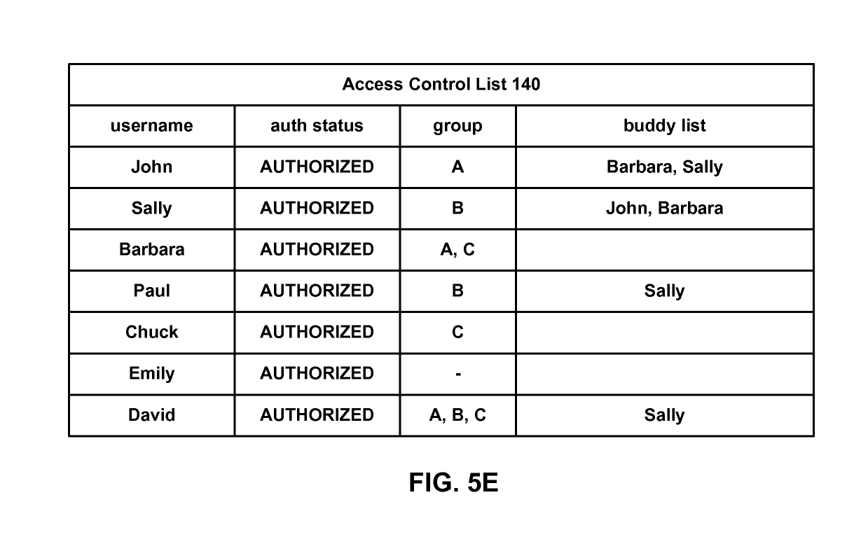

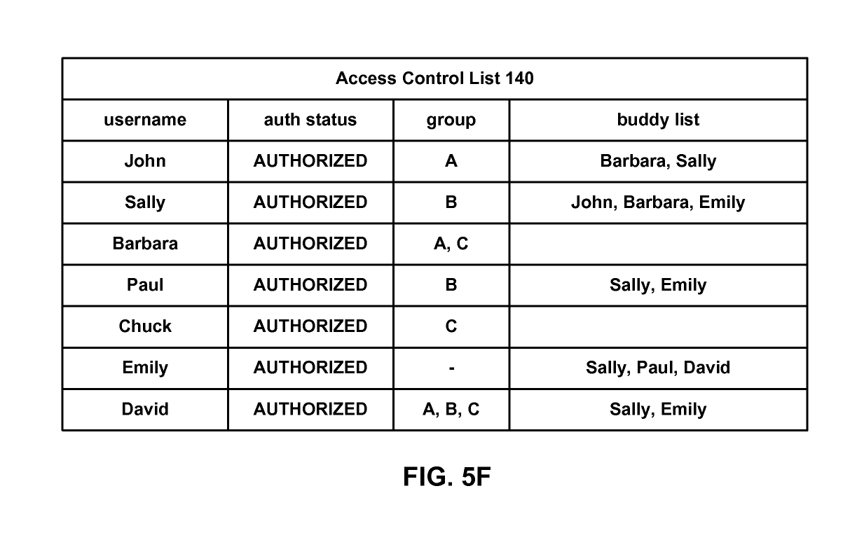

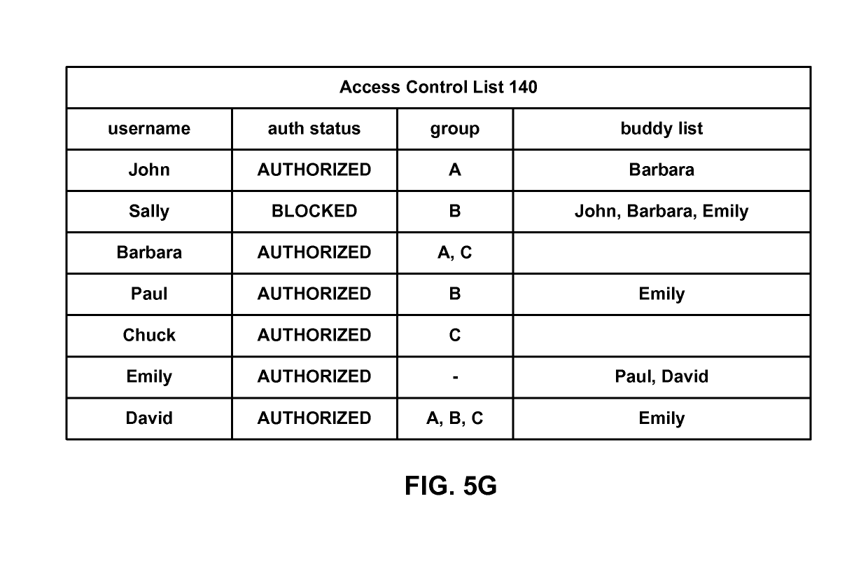

FIG. 5A illustrates an example ACL 140, which lists usernames of users of Messaging Clients 116a, 116b, 116c, . . . , 116N, and the authorization status associated with each username. In addition, ACL 140 may include any group status and the buddy list associated with each username. For example, username “John” has an associated authorization status of AUTHORIZED, is a member of group A, and has no usernames included in his buddy list. In contrast, username “Emily” has an associated authorization status of AUTHORIZED, is not a member of any group, and has no usernames in her buddy list. Persons of ordinary skill in the art will understand that ACL 140 may include more or fewer than the number of usernames shown in FIG. 5A, and may include more or less information than that shown in FIG. 5A

Referring again to FIGS. 3 and 4, at step 156, BACS 132 processes the received Message based on the authorization status received from Authorization Server 134. If the associated authorization status is “BLOCKED,” BACS 132 rejects the received message and process 150 ends. For example, BACS 132 may delete the received Message without any further processing, or may inform the Sender that the received Message has been rejected. If the associated authorization status is “AUTHORIZED,” at step 158 BACS 132 forwards the received Message to Message Processor 136, which extracts the content and metadata (collectively referred to herein as “Message Content”) from the received Message, and provides the Message Content to Rules Engine 138, which compares the Message Content to predetermined criteria in Criteria and Rules Database 142 to determine if the Message Content matches any predetermined criteria. If the Message Content matches any predetermined criteria, Rules Engine 138 provides to Message Processor 136 the rules corresponding to the matching criteria.

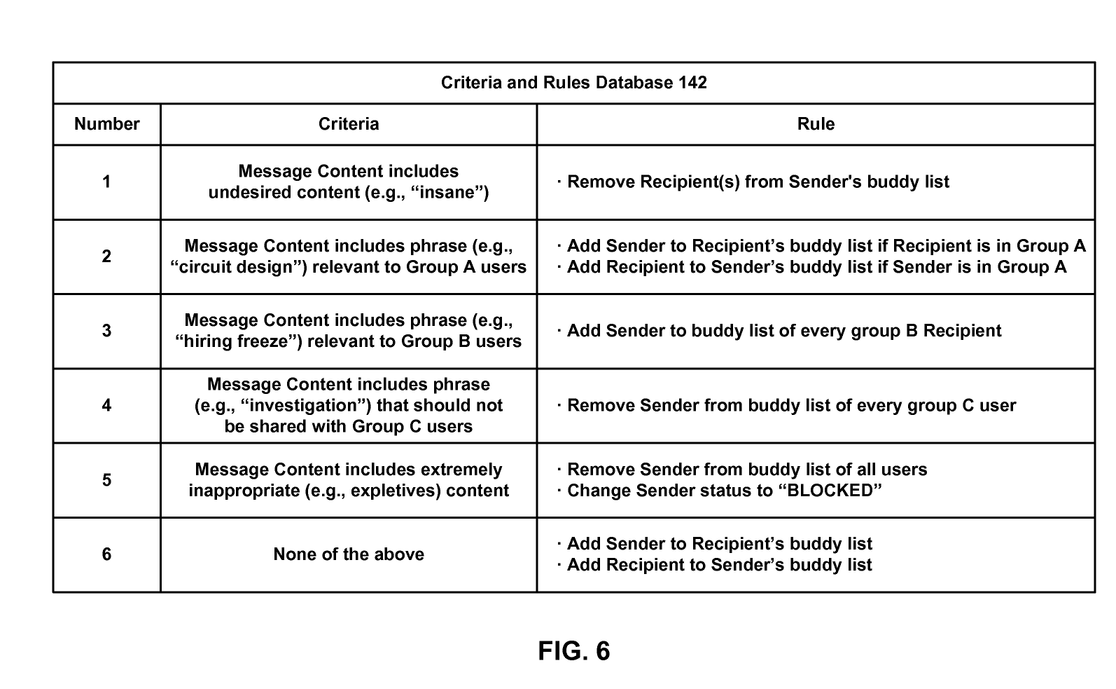

FIG. 6 illustrates an example Criteria and Rules Database 142 which includes predetermined criteria and corresponding rules. The predetermined criteria may specify any predetermined criteria that can be searched for and identified in the Message Content, such a specific words, phrases, names, images, audio content, video content, or any other searchable items that may be included in Message Content.

For example, as shown in FIG. 6, Criteria and Rules Database 142 may include a first predetermined criterion specifying that the Message Content includes undesirable content (e.g., the word “insane”), a second predetermined criterion that the Message Content includes a phrase “circuit design” relevant to Group A users, a third predetermined criterion that the Message Content includes a phrase “hiring freeze” relevant to Group B users, a fourth predetermined criterion that the Message Content includes the word “investigation” that should not be shared with Group C users, a fifth predetermined criterion that the Message Content includes extremely inappropriate content (e.g., expletives), and a sixth predetermined criterion that the Message Content does not include any content that matches the first to the fifth predetermined criteria. Persons of ordinary skill in the art will understand that Criteria and Rules Database 142 may include more or fewer that six predetermined criteria, and may include criteria other than the ones illustrated in FIG. 6.

Each predetermined criterion in Criteria and Rules Database 142 has an corresponding rule. For example, the rule corresponding to the first predetermined criterion may specify that the Recipient(s) shall be removed from the Sender's buddy list, the rule corresponding to the third predetermined criterion may specify that Sender shall be added to the buddy list of every Group B Recipient, and the rule corresponding to the fourth predetermined criterion may specify that Sender shall be removed from the buddy list of all users, and the Sender's authorization status shall be changed to BLOCKED. Persons of ordinary skill in the art will understand that Criteria and Rules Database 142 may include corresponding rules other than the ones illustrated in FIG. 6.

Referring again to FIGS. 3 and 4, at step 160, Message Processor 136 determines from Rules Engine 138 if the Message Content matched any predetermined criteria. If the Message Content did not match any predetermined criteria, at step 162, Message Processor 136 send the Message via first network 104a to Messaging Server 114, and process 150 ends. Alternatively, if the Message Content matched any predetermined criteria, at step 164, Message Processor 136 applies the rules corresponding to the matched criteria. For example, if the Message Content matched the fifth predetermined criterion in the Criteria and Rules Database 142 shown in FIG. 6, Message Processor 136 would instruct Authorization Server 134 to modify ACL 140 to remove the Sender from the buddy list of all users, and change the Sender's authorization status to “BLOCKED.”

Referring again to FIGS. 3 and 4, at step 166, BACS 132 again determines the authorization status associated with the Sender by forwarding the Sender's username to Authorization Server 134, which uses ACL 140 to determine the authorization status associated with the received username, and then provides the associated authorization status to BACS 132.

At step 168, BACS 132 processes the received Message based on the authorization status received from Authorization Server 134. If the associated authorization status is “BLOCKED,” BACS 132 rejects the received message and process 150 ends. For example, BACS 132 may delete the received Message without any further processing, or may inform the Sender that the received Message has been rejected. If the associated authorization status is “AUTHORIZED,” at step 162, Message Processor 136 sends the Message via first network 104a to Messaging Server 114, and process 150 ends.

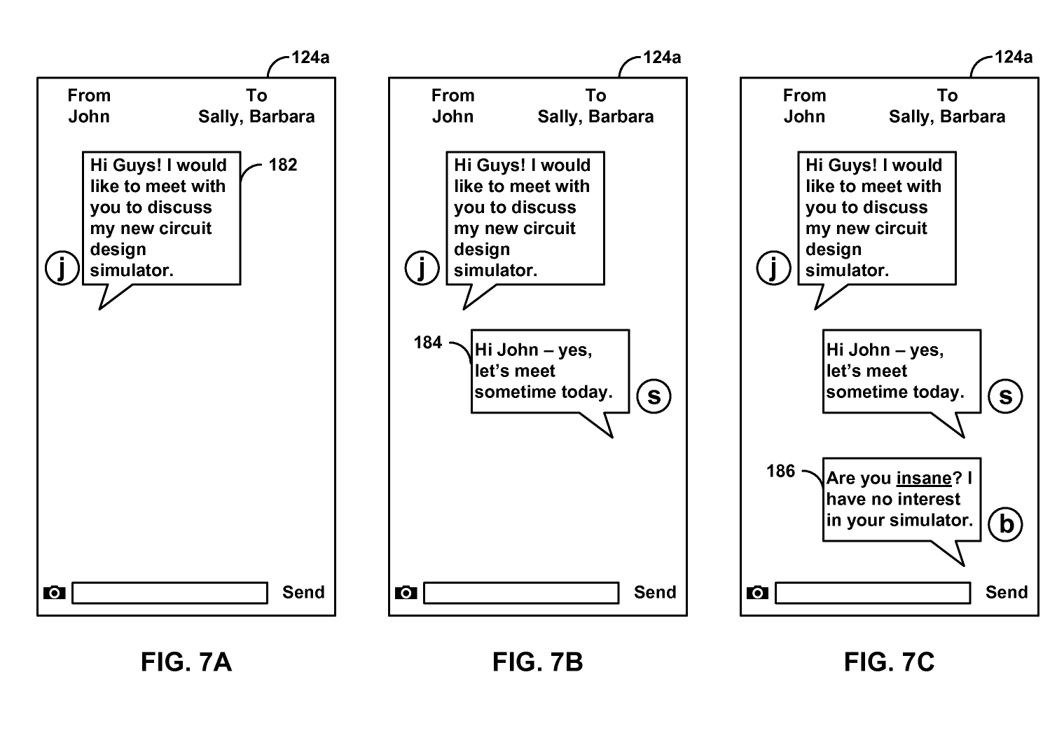

To illustrate the operation of process 150 in conjunction with the example Criteria and Rules Database 142 of FIG. 6, FIGS. 7A-7C illustrate example Messages exchanged between Messaging Client 116a (username “John”), 116b (username “Sally”) and 116c (username “Barbara”), to show how Content-Based Message Authorization Proxy 130 selectively forwards the Messages to Messaging Server 114 based on the Sender's authorization status, and applies a set of predetermined rules to dynamically control the names included in the buddy lists on Messaging Clients 116a, 116b and 116c based on the Message Content. For simplicity, Messaging Clients 116a, 116b and 116c will be referred to in this example by the associated usernames John, Sally and Barbara, respectively. FIGS. 7A-7C illustrate John's Message Window 124a. FIG. 5A illustrates the contents of ACL 140 prior to any Messages being exchanged by John, Sally and Barbara. Prior to any Message exchange, the buddy lists of all users are empty.

As shown in FIG. 7A, John sends a Message to Sally and Barbara. Referring to FIG. 4, at step 152, BACS 132 receives the Message from John, and at step 154, BACS 132 forwards John's username to Authorization Server 134, which determines from ACL 140 (FIG. 5A) that John's authorization status is “AUTHORIZED,” and provides the determined authorization status to BACS 132. At step 156, BACS 132 processes the received Message based on the authorization status received from Authorization Server 134.

Thus, because John's authorization status is “AUTHORIZED,” at step 158, BACS 132 forwards the received Message to Message Processor 136, which extracts the Message Content from the received Message, and provides the Message Content to Rules Engine 138, which compares the Message Content to predetermined criteria in Criteria and Rules Database 142 and determines that John's Message Content includes the phrase “circuit design,” which matches the second predetermined criterion in Criteria and Rules Database 142.

Rules Engine 138 provides to Message Processor 136 the rules corresponding to the matching criteria, i.e., “Add Sender to Recipient's buddy list if Recipient is in Group A, and Add Recipient to Sender's buddy list if Sender is in Group A.” Thus, at step 164, Message Processor 136 instructs Authorization Server 134 to modify ACL 140 to add John to Barbara's buddy list (Barbara is in Group A), and add Barbara to John's buddy list (John is in Group A). FIG. 5B illustrates the content of ACL 140 following these changes.

Next, at step 166, BACS 132 again forwards John's username to Authorization Server 134, which determines from ACL 140 (FIG. 5B) that John's authorization status is “AUTHORIZED,” and provides the determined authorization status to BACS 132. At step 168, BACS 132 processes the received Message based on the authorization status received from Authorization Server 134. Because John's associated authorization status is “AUTHORIZED,” at step 162, Message Processor 136 sends the Message via first network 104a to Messaging Server 114, and process 150 ends.

As shown in FIG. 7B, Sally sends a message replying to John and Barbara. Referring to FIG. 4, at step 152, BACS 132 receives the Message from Sally, and at step 154, BACS 132 forwards Sally's username to Authorization Server 134, which determines from ACL 140 (FIG. 5B) that Sally's authorization status is “AUTHORIZED,” and provides the determined authorization status to BACS 132. At step 156, BACS 132 processes the received Message based on the authorization status received from Authorization Server 134.

Thus, because Sally's authorization status is “AUTHORIZED,” at step 158, BACS 132 forwards the received Message to Message Processor 136, which extracts the Message Content from the received Message, and provides the Message Content to Rules Engine 138, which compares the Message Content to predetermined criteria in Criteria and Rules Database 142 and determines that Sally's Message Content matches the sixth predetermined criterion in Criteria and Rules Database 142.

Rules Engine 138 provides to Message Processor 136 the rules corresponding to the matching criteria, i.e., “Add Sender to Recipient's buddy list, and Add Recipient to Sender's buddy list.” Thus, at step 164, Message Processor 136 instructs Authorization Server 134 to modify ACL 140 to add Sally to each of John's and Barbara's buddy list, and add John and Barbara to Sally's buddy list. FIG. 5C illustrates the content of ACL 140 following these changes.

Next, at step 166, BACS 132 again forwards Sally's username to Authorization Server 134, which determines from ACL 140 (FIG. 5C) that Sally's authorization status is “AUTHORIZED,” and provides the determined authorization status to BACS 132. At step 168, BACS 132 processes the received Message based on the authorization status received from Authorization Server 134. Because Sally's associated authorization status is “AUTHORIZED,” at step 162, Message Processor 136 sends the Message via first network 104a to Messaging Server 114, and process 150 ends. Sally's Message appears on John's Message Window 124a.

As shown in FIG. 7C, Barbara sends a message replying to John and Sally. Referring to FIG. 4, at step 152, BACS 132 receives the Message from Barbara, and at step 154, BACS 132 forwards Barbara's username to Authorization Server 134, which determines from ACL 140 (FIG. 5C) that Barbara's authorization status is “AUTHORIZED,” and provides the determined authorization status to BACS 132. At step 156, BACS 132 processes the received Message based on the authorization status received from Authorization Server 134.

Thus, because Barbara's authorization status is “AUTHORIZED,” at step 158, BACS 132 forwards the received Message to Message Processor 136, which extracts the Message Content from the received Message, and provides the Message Content to Rules Engine 138, which compares the Message Content to predetermined criteria in Criteria and Rules Database 142 and determines that Barbara's Message Content includes the word “insane,” which matches the first predetermined criterion in Criteria and Rules Database 142.

Rules Engine 138 provides to Message Processor 136 the rules corresponding to the matching criteria, i.e., “Remove Recipient(s) from Sender's buddy list.” Thus, at step 164, Message Processor 136 instructs Authorization Server 134 to modify ACL 140 to remove John's and Sally's names from Barbara's buddy list. FIG. 5D illustrates the content of ACL 140 following these changes.

Next, at step 166, BACS 132 again forwards Barbara's username to Authorization Server 134, which determines from ACL 140 (FIG. 5D) that Barbara's authorization status is “AUTHORIZED,” and provides the determined authorization status to BACS 132. At step 168, BACS 132 processes the received Message based on the authorization status received from Authorization Server 134. Because Barbara's associated authorization status is “AUTHORIZED,” at step 162, Message Processor 136 sends the Message via first network 104a to Messaging Server 114, and process 150 ends. Barbara's Message appears on John's Message Window 124a. Thus, as shown in FIGS. 3-7C, Content-Based Message Authorization Proxy 130 selectively forwards Messages received from Messaging Clients 116a, 116b, 116c, . . . , 116N to Messaging Server 114 based on the Sender's authorization status, and applies a set of predetermined rules to dynamically control the usernames included in the buddy lists on Messaging Clients 116a, 116b, 116c, . . . , 116N based on the content of Messages exchanged between Messaging Client users.

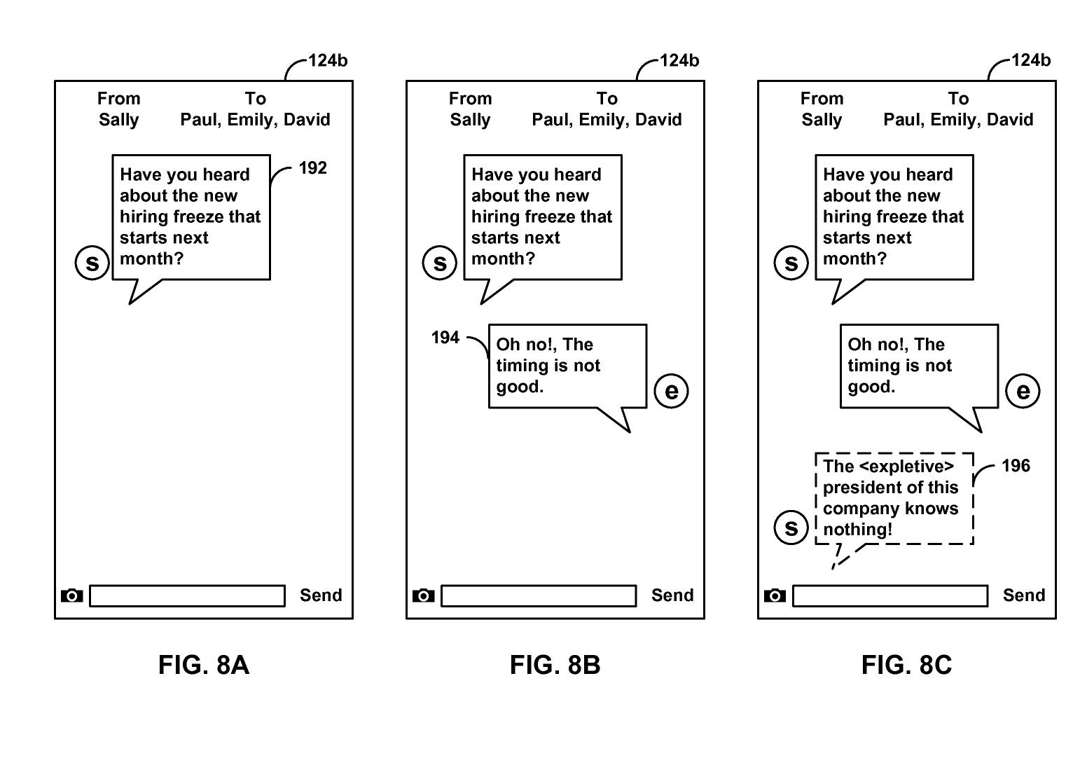

To further illustrate the operation of process 150 in conjunction with the example Criteria and Rules Database 142 of FIG. 6, FIGS. 8A-8C illustrate example Messages exchanged between Messaging Client 116b (username “Sally”), 116d (username “Paul”), 116e (username “Emily”), and 116f (username “David”) to show how Content-Based Message Authorization Proxy 130 selectively forwards the Messages to Messaging Server 114 based on the Sender's authorization status, and applies a set of predetermined rules to dynamically control the names included in the buddy lists on Messaging Clients 116b, 116d, 116e and 116f based on the Message Content. For simplicity, Messaging Clients 116b, 116d, 116e and 116f will be referred to in this example by the associated usernames Sally, Paul, Emily and David, respectively. FIGS. 8A-8C illustrate Sally's Message Window 124b. FIG. 5D illustrates the contents of ACL 140 prior to any Messages being exchanged by Sally, Paul, Emily and David.

As shown in FIG. 8A, Sally sends a Message to Paul, Emily and David. Referring to FIG. 4, at step 152, BACS 132 receives the Message from Sally, and at step 154, BACS 132 forwards Sally's username to Authorization Server 134, which determines from ACL 140 (FIG. 5D) that Sally's authorization status is “AUTHORIZED,” and provides the determined authorization status to BACS 132. At step 156, BACS 132 processes the received Message based on the authorization status received from Authorization Server 134.

Thus, because Sally's authorization status is “AUTHORIZED,” at step 158, BACS 132 forwards the received Message to Message Processor 136, which extracts the Message Content from the received Message, and provides the Message Content to Rules Engine 138, which compares the Message Content to predetermined criteria in Criteria and Rules Database 142 and determines that Sally's Message Content includes the phrase “hiring freeze,” which matches the third predetermined criterion in Criteria and Rules Database 142.

Rules Engine 138 provides to Message Processor 136 the rules corresponding to the matching criteria, i.e., “Add Sender to buddy list of every group B Recipient.” Thus, at step 164, Message Processor 136 instructs Authorization Server 134 to modify ACL 140 to add Sally to each of Paul's and David's buddy list (Paul and David are in Group B). FIG. 5E illustrates the content of ACL 140 following these changes.

Next, at step 166, BACS 132 again forwards Sally's username to Authorization Server 134, which determines from ACL 140 (FIG. 5E) that Sally's authorization status is “AUTHORIZED,” and provides the determined authorization status to BACS 132. At step 168, BACS 132 processes the received Message based on the authorization status received from Authorization Server 134. Because Sally's associated authorization status is “AUTHORIZED,” at step 162, Message Processor 136 sends the Message via first network 104a to Messaging Server 114, and process 150 ends.

As shown in FIG. 8B, Emily sends a message replying to Sally, Paul and David. Referring to FIG. 4, at step 152, BACS 132 receives the Message from Emily, and at step 154, BACS 132 forwards Emily's username to Authorization Server 134, which determines from ACL 140 (FIG. 5E) that Emily's authorization status is “AUTHORIZED,” and provides the determined authorization status to BACS 132. At step 156, BACS 132 processes the received Message based on the authorization status received from Authorization Server 134.

Thus, because Emily's authorization status is “AUTHORIZED,” at step 158, BACS 132 forwards the received Message to Message Processor 136, which extracts the Message Content from the received Message, and provides the Message Content to Rules Engine 138, which compares the Message Content to predetermined criteria in Criteria and Rules Database 142 and determines that Emily's Message Content matches the sixth predetermined criterion in Criteria and Rules Database 142.

Rules Engine 138 provides to Message Processor 136 the rules corresponding to the matching criteria, i.e., “Add Sender to Recipient's buddy list, and Add Recipient to Sender's buddy list.” Thus, at step 164, Message Processor 136 instructs Authorization Server 134 to modify ACL 140 to add Emily to each of Sally's, Paul's and David's buddy list, and add Sally, Paul and David to Emily's buddy list. FIG. 5F illustrates the content of ACL 140 following these changes.

Next, at step 166, BACS 132 again forwards Emily's username to Authorization Server 134, which determines from ACL 140 (FIG. 5F) that Emily's authorization status is “AUTHORIZED,” and provides the determined authorization status to BACS 132. At step 168, BACS 132 processes the received Message based on the authorization status received from Authorization Server 134. Because Emily's associated authorization status is “AUTHORIZED,” at step 162, Message Processor 136 sends the Message via first network 104a to Messaging Server 114, and process 150 ends. Emily's Message appears on Sally's Message Window 124b.

As shown in FIG. 8C, Sally sends a message replying to John and Paul, Emily and David. Referring to FIG. 4, at step 152, BACS 132 receives the Message from Sally, and at step 154, BACS 132 forwards Sally's username to Authorization Server 134, which determines from ACL 140 (FIG. 5F) that Sally's authorization status is “AUTHORIZED,” and provides the determined authorization status to BACS 132. At step 156, BACS 132 processes the received Message based on the authorization status received from Authorization Server 134.

Thus, because Sally's authorization status is “AUTHORIZED,” at step 158, BACS 132 forwards the received Message to Message Processor 136, which extracts the Message Content from the received Message, and provides the Message Content to Rules Engine 138, which compares the Message Content to predetermined criteria in Criteria and Rules Database 142 and determines that Sally's Message Content includes an expletive, which matches the fifth predetermined criterion in Criteria and Rules Database 142.

Rules Engine 138 provides to Message Processor 136 the rules corresponding to the matching criteria, i.e., “Remove Sender from buddy list of all users, and Change Sender status to “BLOCKED.” Thus, at step 164, Message Processor 136 instructs Authorization Server 134 to modify ACL 140 to remove Sally's name from all buddy lists, and to change Sally's associated authorization status to BLOCKED. FIG. 5G illustrates the content of ACL 140 following these changes.

Next, at step 166, BACS 132 again forwards Sally's username to Authorization Server 134, which determines from ACL 140 (FIG. 5G) that Sally's authorization status is “BLOCKED,” and provides the determined authorization status to BACS 132. At step 168, BACS 132 processes the received Message based on the authorization status received from Authorization Server 134. Because Sally's associated authorization status is “BLOCKED,” BACS 132 rejects the received message and process 150 ends. Sally's Message does not appear on any user's Message Window 124. Thus, as shown in FIGS. 3-8C, Content-Based Message Authorization Proxy 130 selectively forwards Messages received from Messaging Clients 116a, 116b, 116c, . . . , 116N to Messaging Server 114 based on the Sender's authorization status, and applies a set of predetermined rules to dynamically control the usernames included in the buddy lists on Messaging Clients 116a, 116b, 116c, . . . , 116N based on the content of Messages exchanged between Messaging Client users.

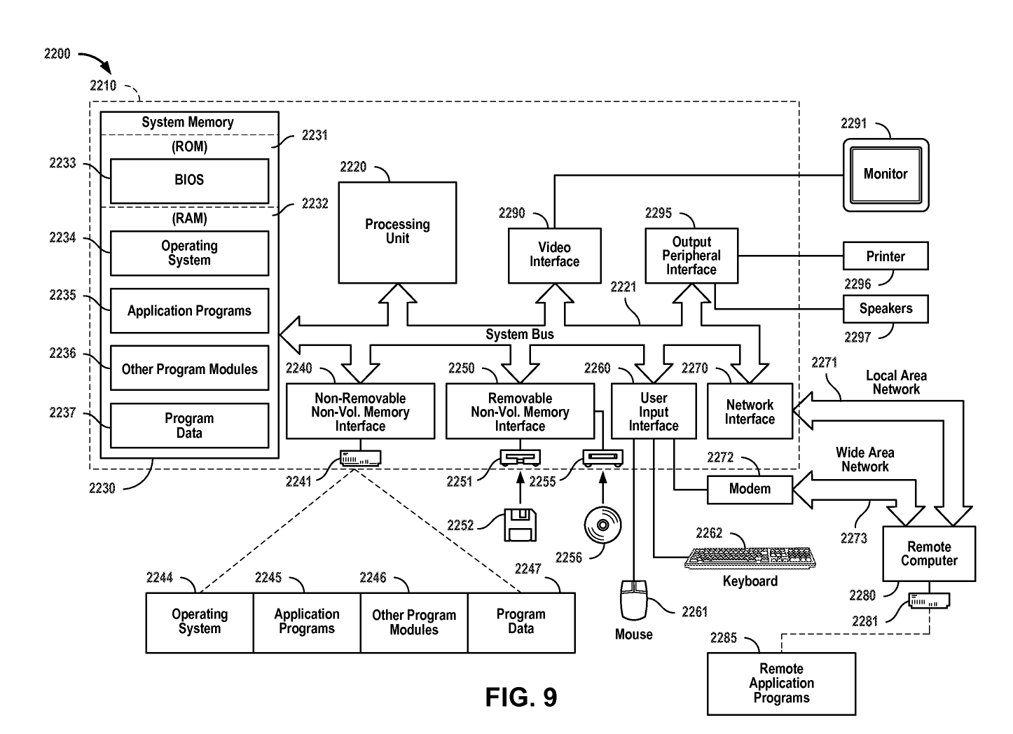

The disclosed technology may be used with various computing systems or computing devices. FIG. 9 is a block diagram of an embodiment of a system environment 2200. Computing system environment 2200 includes a general purpose computing device in the form of a computer 2210. In an embodiment, first computing device 102 shown in FIG. 1 corresponds to computer 2210. Components of computer 2210 may include, but are not limited to, a processing unit 2220, a system memory 2230, and a system bus 2221 that couples various system components including the system memory 2230 to the processing unit 2220. The system bus 2221 may be any of several types of bus structures including a memory bus, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 2210 typically includes a variety of computer readable media. Computer readable media can be any available media that can be accessed by computer 2210 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disks (DVD) or other optical disk storage, magnetic cassettes, magnetic tape, magnetic disk storage or other magnetic storage devices, or any other medium which can be used to store the desired information and which can accessed by computer 2210. Combinations of the any of the above should also be included within the scope of computer readable media.

The system memory 2230 includes computer storage media in the form of volatile and/or nonvolatile memory such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data and/or program modules that are immediately accessible to and/or presently being operated on by processing unit 2220. The system memory 2230 may store operating system 2234, application programs 2235, other program modules 2236, and program data 2237. In an embodiment, computer program code as described herein may be at least partially stored in application programs 2235.

The computer 2210 may also include other removable/non-removable, volatile/nonvolatile computer storage media. The computer 2210 may include a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2241 is typically connected to the system bus 2221 through an non-removable memory interface such as interface 2240, and magnetic disk drive 2251 and optical disk drive 2255 are typically connected to the system bus 2221 by a removable memory interface, such as interface 2250.

The drives and their associated computer storage media described above provide storage of computer readable instructions, data structures, program modules and other data for the computer 2210. Hard disk drive 2241 is illustrated as storing operating system 2244, application programs 2245, other program modules 2246, and program data 2247. Note that these components can either be the same as or different from operating system 2234, application programs 2235, other program modules 2236, and program data 2237. Operating system 2244, application programs 2245, other program modules 2246, and program data 2247 are given different numbers here to illustrate that, at a minimum, they are different copies. In an embodiment, Content Based Message Authorization Proxy 130 shown FIG. 3 corresponds to application program 2245.

A user may enter commands and information into computer 2210 through input devices such as a keyboard 2262 and pointing device 2261, commonly referred to as a mouse, trackball, or touch pad. Other input devices (not shown) may include a microphone, joystick, game pad, satellite dish, scanner, or the like. These and other input devices are often connected to the processing unit 2220 through a user input interface 2260 that is coupled to the system bus, but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 may operate in a networked environment using logical connections to one or more remote computers, such as a remote computer 2280. The remote computer 2280 may be a personal computer, a server, a router, a network PC, a peer device or other common network node, and typically includes many or all of the elements described above relative to the computer 2210. In an embodiment, second computing device 106, and third computing devices 108a, 108b, 108c, . . . , 108N shown in FIG. 1 each corresponds to remote computer 2280. The logical connections may include a local area network (LAN) 2271 and a wide area network (WAN) 2273, but may also include other networks. Such networking environments are commonplace in offices, enterprise-wide computer networks, intranets and the Internet.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. The modem 2272, which may be internal or external, may be connected to the system bus 2221 via the user input interface 2260, or other appropriate mechanism. In a networked environment, program modules depicted relative to the computer 2210, or portions thereof, may be stored in the remote memory storage device. For example, remote application programs 2285 may reside on memory device 2281. In an embodiment, Messaging Clients 116a, 116b, 116c, . . . , 116N shown in FIG. 1 correspond to remote application programs 2285. It will be appreciated that the network connections shown are exemplary and other means of establishing a communications link between the computers may be used.

The flowchart and block diagrams in the figures illustrate the architecture, functionality, and operation of possible implementations of systems, methods and computer program products according to various aspects of the present disclosure. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A system for use with a plurality of messaging clients, each messaging client running on a corresponding computing device, and comprising a corresponding buddy list, the system comprising:
a server; and
a computer-readable medium in communication with the server, the computer-readable medium having a plurality of instructions stored thereon which, when executed by the server, cause the server to:
receive messages from the messaging clients; and
dynamically control user identification information included in the buddy lists based on content of messages received from the messaging clients.

2. The system of claim 1, wherein the messages comprise one or more of text messages, instant messages, SMS messages, MMS messages, audio messages, and video messages.

3. The system of claim 1, wherein the messaging clients are XMPP messaging clients.

4. The system of claim 1, wherein the plurality of instructions, when executed by the server, further cause the server to:
determine user identification information associated with a received message; and
selectively reject the received message based on the user identification information.

5. The system of claim 1, wherein the plurality of instructions, when executed by the server, further cause the server to:
compare the content of a received message to a predetermined criterion associated with a corresponding rule; and
if the content matches the predetermined criterion, apply the corresponding rule associated with the matching criterion.

6. The system of claim 5, wherein the plurality of instructions, when executed by the server, further cause the server to determine user identification information associated with a received message, and wherein the rule specifies adding or deleting the user identification information to or from the buddy lists.

7. The system of claim 5, wherein the rule specifies rejecting the received message.

8. A computer program product comprising:
a computer readable storage medium having computer readable program code embodied therewith, the computer readable program code comprising:
computer readable program code configured to cause a server to receive messages from a plurality of messaging clients, each messaging client comprising a corresponding buddy list; and
computer readable program code configured to cause the server to dynamically control user identification information included in the buddy lists based on content of messages received from the messaging clients.

9. The computer program product of claim 8, wherein the messages comprise one or more of text messages, instant messages, SMS messages, MMS messages, audio messages, and video messages.

10. The computer program product of claim 8, wherein the messaging clients are XMPP messaging clients

11. The computer program product of claim 8, wherein the computer readable program code further comprises computer readable program code configured to cause the server to:
determine user identification information associated with a received message; and
selectively reject the received message based on the user identification information.

12. The computer program product of claim 8, wherein the computer readable program code further comprises computer readable program code configured to cause the server to:
compare the content of a received message to a predetermined criterion associated with a corresponding rule; and
if the content matches the predetermined criterion, apply the corresponding rule associated with the matching criterion.

13. The computer program product of claim 8, wherein the computer readable program code further comprises computer readable program code configured to cause the server to determine user identification information associated with a received message, and wherein the rule specifies adding or deleting the user identification information to or from the buddy lists.

14. The computer program product of claim 8, wherein the rule specifies rejecting the received message.

15. A method for dynamically controlling buddy lists of messaging clients, each messaging client running on a corresponding computing device, the method comprising:
receiving messages from the messaging clients at a server;
determining content of the received messages at the server; and
dynamically controlling user identification information included in the buddy lists based on the determined content of the received messages at the server.

16. The method of claim 15, wherein the messages comprise one or more of text messages, instant messages, SMS messages, MMS messages, audio messages, and video messages.

17. The method of claim 15, wherein the messaging clients are XMPP messaging clients.

18. The method of claim 15, further comprising:
comparing the content of a received message to a predetermined criterion associated with a corresponding rule; and
if the content matches the predetermined criterion, applying the corresponding rule associated with the matching criterion.

19. The method of claim 18, further comprising determining user identification information associated with a received message, and wherein the rule specifies adding or deleting the user identification information from the buddy lists.

20. The method of claim 18, wherein the rule specifies rejecting the received message.
